(19) United States
(12) Patent Application Publication
(10) Pub. No.: US 2015/0332641 A1
(43) Pub. Date: Nov. 19, 2015

(54) TRANSFLECTIVE PANEL DEVICE

(71) Applicant: InnoLux Corporation, Miao-Li County (TW)

(72) Inventors: Akihiro IWATSU, Miao-Li County (TW); Chien-Feng SHIH, Miao-Li County (TW)

(21) Appl. No.: 14/450,905

(22) Filed: Aug. 4, 2014

Related U.S. Application Data
(60) Provisional application No. 62/027,527, filed on Jul. 22, 2014.
(60) Provisional application No. 61/992,270, filed on May 13, 2014.

(51) Int. Cl. G09G 3/36; G02F 1/133; G09G 3/34; G02F 1/1335

(52) U.S. Cl. CPC G09G 3/3607; G02F 1/133555; G02F 1/13306; G02F 1/13318; G09G 3/3659; G09G 3/3406; G09G 2360/144; G09G 2300/0456; G09G 2300/0478; G09G 2310/08; G09G 2320/08; G09G 2320/0606; G09G 2320/064

(57) ABSTRACT

A transflective panel device includes: a plurality of pixels arranged in columns and rows, each pixel including a transmissive part coupled to a first gate line and a reflective part coupled to a second gate line; a gate driver including a first driving unit and a second driving unit, wherein the first driving unit is coupled to the first gate lines and drives the transmissive parts based on a first driving signal and the second driving unit is coupled to the second gate lines and drives the reflective parts based on a second driving signal; wherein the first driving signal and the second driving signal are controlled independently.

### CROSS REFERENCE TO RELATED APPLICATION

This application claims the benefit of filing date of U. S. Provisional Application Ser. No. 62/027,527, entitled “New Transflective panel concept” filed Jul. 22, 2014 and U. S. Provisional Application Ser. No. 61/992,270, entitled “New Transflective panel concept” filed May 13, 2014 under 35 USC §119(e)(1).

### BACKGROUND OF THE INVENTION

1. Field of the Invention

The present invention relates to a panel device and, more particularly, to a transflective panel device.

2. Description of Related Art

Liquid crystal display panel is typically divided into a transmissive liquid crystal display panel and a reflective liquid crystal display panel. For the transmissive liquid crystal display panel, a backlight source has to be set on the liquid crystal display panel to achieve image display with better brightness. However, energy consumption of the backlight source is accounted for large part of energy consumption of the whole transmissive liquid crystal display panel, and thus energy consumption of the transmissive liquid crystal display panel is usually unsatisfactory. On the other hand, the reflective liquid crystal display panel can solve the problem of high energy consumption as there is no backlight module required, but it suffers the deficiency of poor image display in an environment with low ambient brightness.

In order to have the advantages of the transmissive liquid crystal display panel and the reflective liquid crystal display panel at the same time, a transflective liquid crystal display panel is proposed. FIG. 1 is a schematic diagram of a prior transflective liquid crystal display panel. The transflective liquid crystal display panel includes a plurality of pixels 8 and a gate driver 3. The plurality of pixels 8 are arranged in columns and rows, each pixel 8 includes a transmissive part 81 and a reflective part 82. The gate driver 3 has a plurality of gate lines G₁˜Gₙ, each gate line is arranged to turn on the transmissive parts 81 and the reflective parts 82 of the pixels 8 in one row. When ambient brightness changes, the transflective liquid crystal display panel only can control the plurality of gate lines G₁˜Gₙ to turn on or off the transmissive parts 81 and the reflective parts 82 of the pixels 8 simultaneously and adjust the backlight source. There is no mechanism to control the transmissive parts 81 and the reflective parts 82 of the pixels 8 separately for improving efficiency in using the transflective liquid crystal display panel. Therefore, it is desired to provide an improved transflective panel device to alleviate or mitigate the aforementioned problems.

### SUMMARY OF THE INVENTION

The object of the present invention is to provide a transflective panel device capable of turning on the transmissive parts and the reflective parts of the pixels independently in different display frequencies and display time, respectively, based on the ambient brightness value.

To achieve the object, there is provided a transflective panel device, which comprises: a plurality of pixels arranged in columns and rows, each pixel including a transmissive part coupled to a first gate line and a reflective part coupled to a second gate line; a gate driver including a first driving unit and a second driving unit, wherein the first driving unit is coupled to the first gate lines and drives the transmissive parts based on a first driving signal and the second driving unit is coupled to the second gate lines and drives the reflective parts based on a second driving signal; wherein the first driving signal and the second driving signal are controlled independently.

Other objects, advantages, and novel features of the invention will become more apparent from the following detailed description when taken in conjunction with the accompanying drawings.

### BRIEF DESCRIPTION OF THE DRAWINGS

FIG. 1 is a schematic diagram of a prior transflective panel device;

FIG. 2 is a schematic diagram of a transflective panel device according to the present invention;

FIG. 3 schematically illustrates a part of the transflective panel device according to the present invention

FIG. 4 schematically illustrates an operating time of the transflective panel device in accordance with a first example of the present invention;

FIG. 5 is a scanning frequency diagram of the transflective panel device in accordance with the present invention;

FIG. 6(A) schematically illustrates an operating time of the transflective panel device in accordance with a second example of the present invention;

FIG. 6(B) schematically illustrates an operating time of the transflective panel device in accordance with a third example of the present invention;

FIG. 6(C) schematically illustrates an operating time of the transflective panel device in accordance with a fourth example of the present invention;

FIG. 7 schematically illustrates an operating time of the transflective panel device in accordance with a fifth example of the present invention;

FIG. 8(A) schematically illustrates an operating time of the transflective panel device in accordance with a sixth example of the present invention;

FIG. 8(B) schematically illustrates an operating time of the transflective panel device in accordance with a seventh example of the present invention;

FIG. 9 is a schematic diagram showing the operation of the transflective panel device according to the present invention; and

FIGS. 10(A)-10(D) are the driving diagrams of the transflective panel device for the transmissive mode in accordance with the present invention.

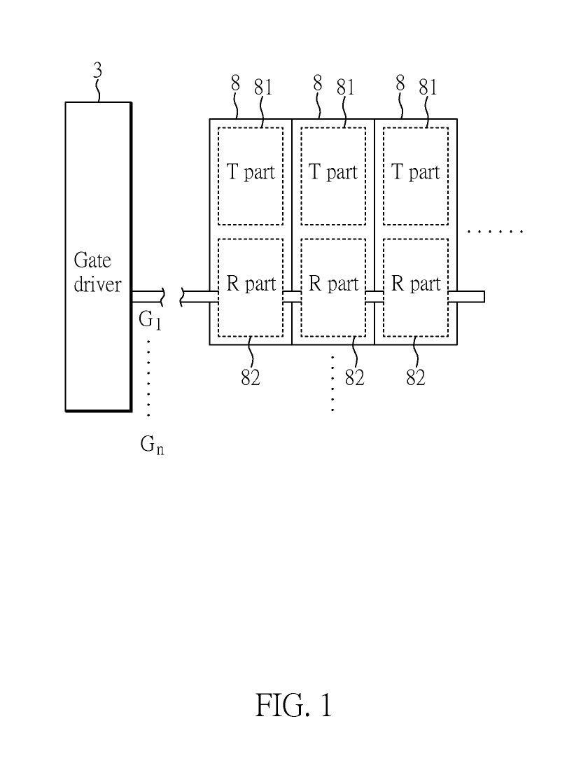

### DETAILED DESCRIPTION OF THE PREFERRED EMBODIMENT

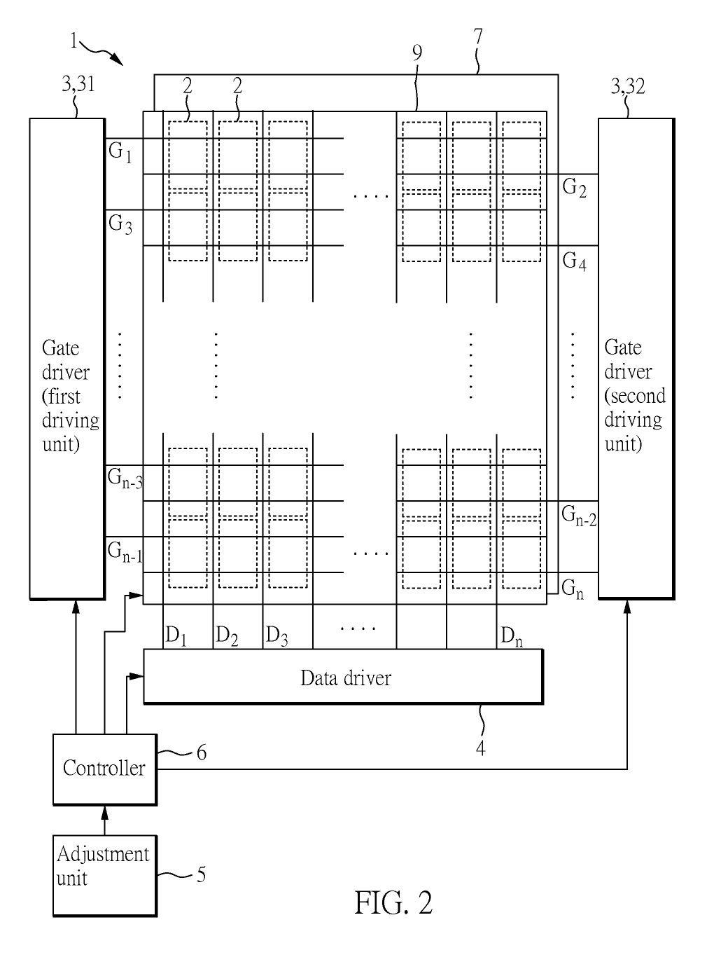

FIG. 2 is a schematic diagram of a transflective panel device according to the present invention. The transflective panel device 1 comprises: a plurality of pixels 2 arranged in columns and rows of a panel 9, a gate driver 3 including a first driving unit 31 and a second driving unit 32, a data driver 4, an adjustment unit 5, a controller 6, and a backlight module 7. In this embodiment, the first driving unit 31 and second driving unit 32 are arranged at two opposite sides of the plurality of pixels 2 of the panel 9, and the data driver 4 is arranged at the bottom side of the plurality of pixels 2 of the panel 9. Alternatively, the data driver 4 may be arranged at the top side of the plurality of pixels 2 of the panel 9.

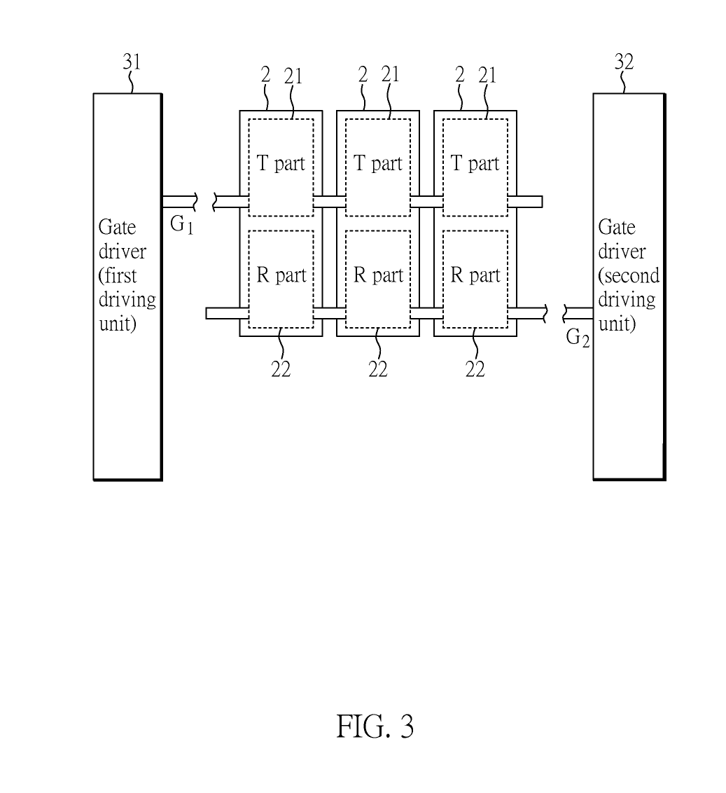

FIG. 3 schematically illustrates a part of the transflective panel device according to the present invention for describing the operation thereof in detail. As shown in FIGS. 2 and 3, each of the plurality of pixels 2 arranged in columns and rows includes a transmissive part (T part) 21 and a reflective part (R part) 22. Each transmissive part 21 is coupled to a first gate line (G₁, G₃, . . . , or Gₙ₋₁) and a corresponding data line (D₁, D₂, . . . , or Dₙ) through a thin-film transistor (not shown) and each reflective part 22 is coupled to a second gate line (G₂, G₄, . . . , or Gₙ) and a corresponding data line (D₁, D₂, . . . , or Dₙ) through a thin-film transistor (not shown).

In this embodiment the first driving unit 31 is arranged at a first side, e.g. left-hand side, of the plurality of pixels 2 and the second driving unit 32 is arranged at a second side, e.g. right-hand side, of the plurality of pixels 2 opposite to the first side. The first driving unit 31 is coupled to the first gate lines G₁, G₃, G₅, . . . , and Gₙ₋₁ and drives the transmissive parts 21 based on a first driving signal and the second driving unit 32 is coupled to the second gate lines G₂, G₄, G₆, . . . , and Gₙ and drives the reflective parts 22 based on a second driving signal, in which the first driving signal and the second driving signal are controlled independently. There are two of the gate lines arranged to drive the transmissive parts 21 and the reflective parts 22 of the pixels 2 in one row, respectively. As shown in FIG. 3, two gate lines G₁ and G₂ are arranged to drive the transmissive parts 21 and the reflective parts 22 of the pixels 2 in one row, respectively.

In other embodiments, the first and second driving units 31, 32 may be both arranged at the same side of the plurality of pixels 2. Alternatively, the gate driver 3 may have the functions of both first and second driving units 31 and 32, i.e., the only one gate driver 3 being arranged to drive the transmissive parts 21 and the reflective parts 22 of the pixels 2 in one row, respectively.

The data driver 4 has a plurality of data lines D₁˜Dₙ, and each data line is arranged to provide the pixels 2 in one column with data voltages.

The adjustment unit 5 is used for providing an adjustment value corresponding to ambient brightness or a human controlling. The adjustment unit 5 is preferably a light sensor for sensing the ambient light to provide the adjustment value. In other embodiments, the adjustment unit 5 is manually operated by user to provide the adjustment value.

The controller 6 is connected to the first and second driving units 31, 32 and the data driver 4 for controlling the gate lines G₁˜Gₙ to drive the transmissive parts 21 based on the first driving signal and the reflective parts 22 of the pixels 2 based on the second driving signal, respectively, and controlling the data lines D₁˜Dₙ to selectively provide the data voltages for performing a display operation, in which a scanning frequency of the first driving signal is different from that of the second driving signal and a pulse width of the first driving signal is different from that of the second driving signal.

The backlight module 7 is controlled by the controller 6 to provide a light based on the adjustment value.

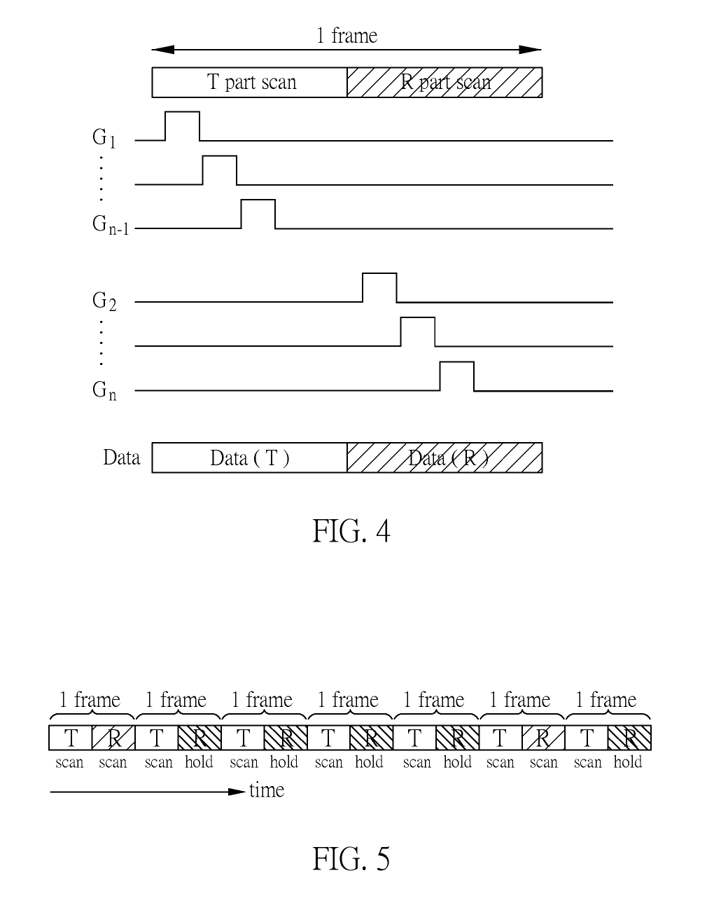

FIG. 4 schematically illustrates an operating time of the transflective panel device in accordance with a first example of the present invention. As shown in FIG. 4, in one frame that represents the operating time of an image, the first driving unit 31 drives the transmissive parts 21 of the pixels 2 one by one via the gate lines G₁, G₃, G₅, . . . , and Gₙ₋₁ based on the first driving signal while the data driver 4 provides the transmissive parts 21 of the pixels 2 with the data voltages Data(T) via the data lines D₁˜Dₙ during a transmissive part scanning time (T part scan). The second driving unit 32 then drives the reflective parts 22 of the pixels 2 one by one via the gate lines G₂, G₄, G₆, . . . , and Gₙ based on the second driving signal while the data driver 4 provides the reflective parts 22 of the pixels 2 with the data voltages Data(R) via the data lines D₁·Dₙ during a reflective part scanning time (R part scan). The pulse width of the first driving signal in which the transmissive parts 21 of the pixels 2 are driven is equal to the pulse width of the second driving signal in which the reflective parts 22 of the pixels 2 are driven.

FIG. 5 is a scanning frequency diagram of the transflective panel device in accordance with the present invention. As shown in FIG. 5, when the transmissive part scanning time has a scanning frequency of 50 Hz and the reflective part scanning time has a scanning frequency of 10 Hz in the operating time, the reflective part scanning time appears one time while the transmissive part scanning time appears five times during every five frames. The first and second driving units 31, 32 thus can drive the transmissive parts 21 and the reflective parts 22 of the pixels 2 in different scanning frequencies of the driving signal, respectively.

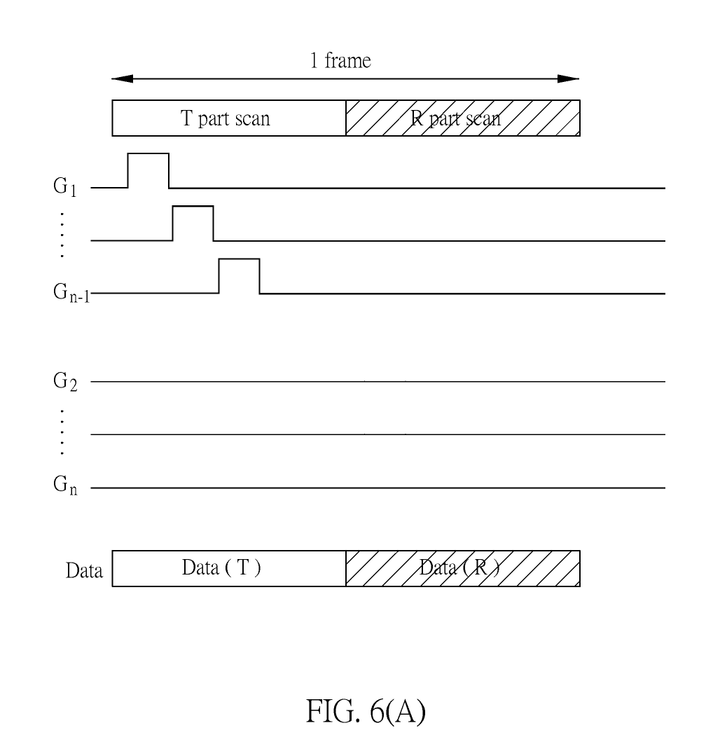

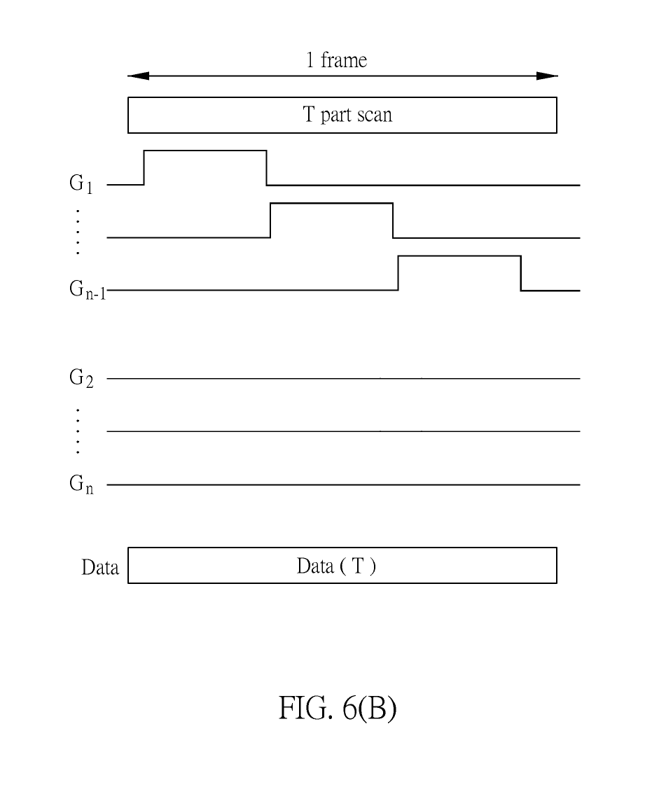

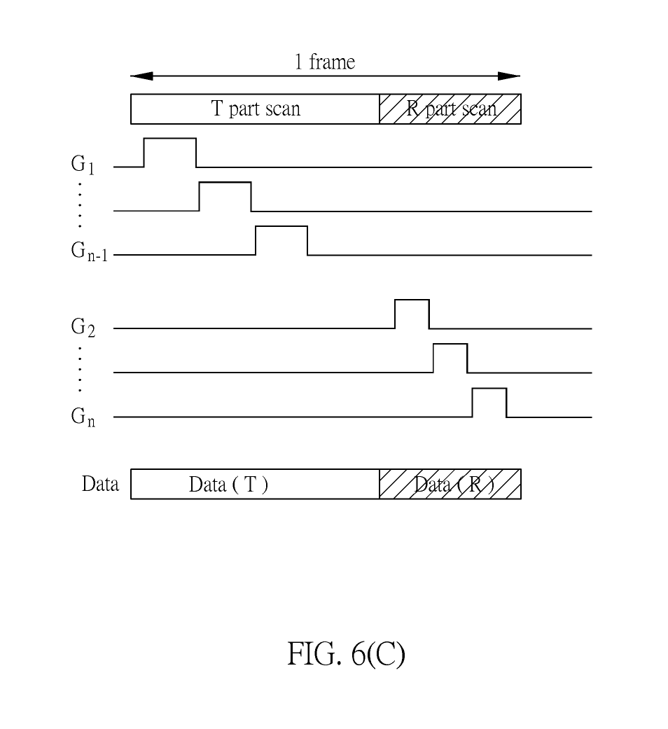

FIG. 6(A) schematically illustrates an operating time of the transflective panel device in accordance with a second example of the present invention. FIG. 6(A) is similar to FIG. 4 except that the second driving unit 32 doesn't drive the reflective parts 22 of the pixels 2 as shown in a second frame of FIG. 5 for decreasing energy consumption when the reflective parts 22 of the pixels 2 are unnecessary and don't be driven.

In other examples, similarly, it is applicable that the second driving unit 32 drives the reflective parts 22 of the pixels 2 and the first driving unit 31 doesn't drive the transmissive parts 21 of the pixels 2 when the transmissive parts 21 of the pixels 2 are unnecessary and don't be driven.

FIG. 6(B) schematically illustrates an operating time of the transflective panel device in accordance with a third example of the present invention. FIG. 6(B) is similar to FIG. 4 except that the first driving unit 31 drives the transmissive parts 21 of the pixels 2 in the whole frame for improving efficiency when the reflective parts 22 of the pixels 2 are unnecessary and don't be driven.

In other examples, similarly, it is applicable that the second driving unit 32 drives the reflective parts 22 of the pixels 2 in the whole frame when the transmissive parts 21 of the pixels 2 are unnecessary and don't be driven.

FIG. 6(C) schematically illustrates an operating time of the transflective panel device in accordance with a fourth example of the present invention. FIG. 6(C) is similar to FIG. 4 except that the pulse width of the first driving signal in which the transmissive parts 21 of the pixels 2 are driven is larger than the pulse width of the second driving signal in which the reflective parts 22 of the pixels 2 are driven. The first and second driving units 31, 32 can freely drive the transmissive parts 21 and the reflective parts 22 of the pixels 2 in different pulse widths of the driving signal in a frame for improving efficiency and decreasing energy consumption.

In other examples, similarly, it is applicable that the pulse width of the second driving signal in which the reflective parts 22 of the pixels 2 are driven is larger than the pulse width of the first driving signal in which the transmissive parts 21 of the pixels 2 are driven.

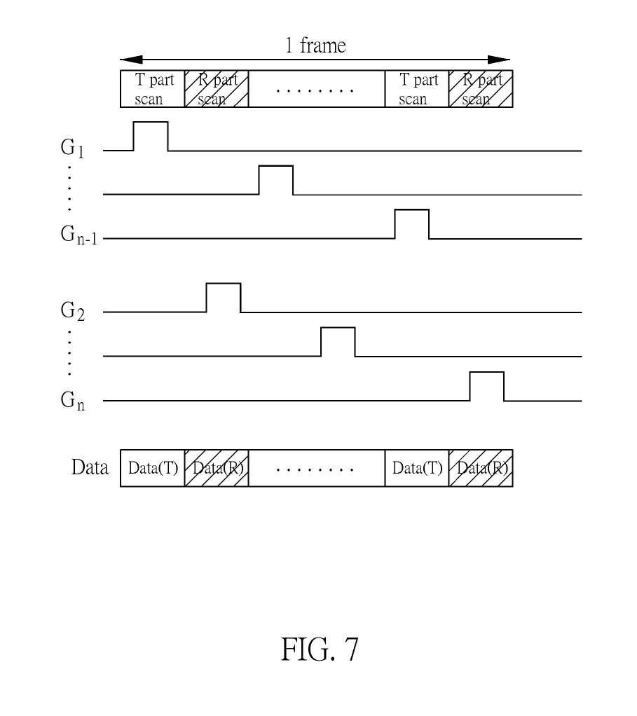

FIG. 7 schematically illustrates an operating time of the transflective panel device in accordance with a fifth example of the present invention. As shown in FIG. 7, in one frame that represents the operating time of an image, the first driving unit 31 drives the transmissive parts 21 of the pixels 2 and the second driving unit 32 drives the reflective parts 22 of the pixels 2 in sequence via the gate lines G₁˜Gₙ based on the first and second driving signals while the data driver 4 provides the transmissive parts 21 of the pixels 2 with the data voltages (Data(T) or Data (R)) via the data lines D₁˜Dₙ during the transmissive part scanning time (T part scan) and the reflective part scanning time (R part scan), respectively. The pulse width of the first driving signal in which the transmissive parts 21 of the pixels 2 are driven is equal to the pulse width of the second driving signal in which the reflective parts 22 of the pixels 2 are driven.

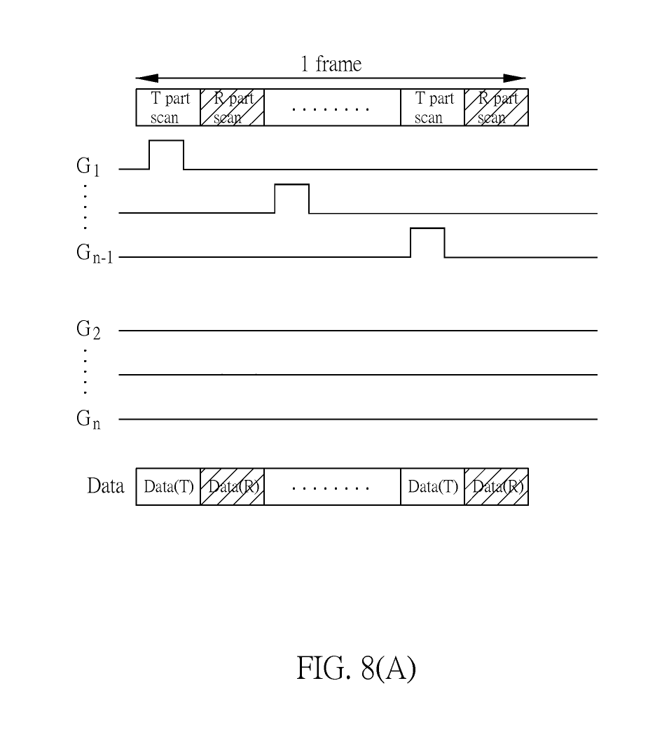

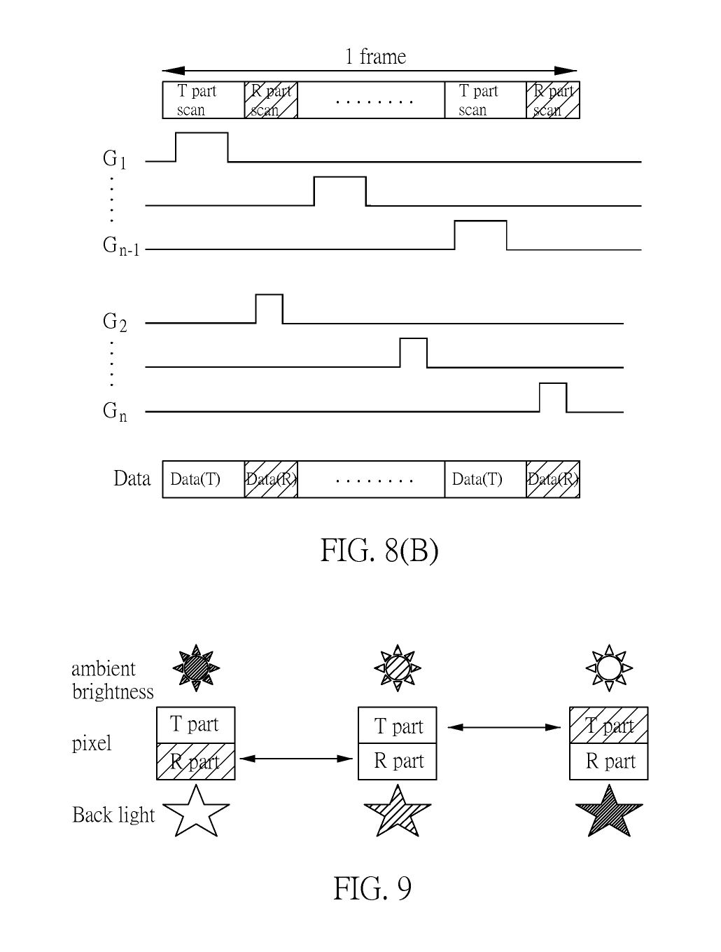

FIG. 8(A) schematically illustrates an operating time of the transflective panel device in accordance with a sixth example of the present invention. FIG. 8(A) is similar to FIG. 7 except that the second driving unit 32 doesn't drive the reflective parts 22 of the pixels 2 for decreasing energy consumption when the reflective parts 22 of the pixels 2 are unnecessary and don't be driven.

In other examples, similarly, it is applicable that the second driving unit 32 drives the reflective parts 22 of the pixels 2 and the first driving unit 3 doesn't drive the transmissive parts 21 of the pixels 2 when the transmissive parts 21 of the pixels 2 are unnecessary and don't be driven.

In other examples, it is applicable that the first driving unit 31 drives the transmissive parts 21 of the pixels 2 in the whole frame, as shown in FIG. 6(B), when the reflective parts 22 of the pixels 2 are unnecessary and don't be driven.

In other examples, similarly, it is applicable that the second driving unit 32 drives the reflective parts 22 of the pixels 2 in the whole frame when the transmissive parts 21 of the pixels 2 are unnecessary and don't be driven.

FIG. 8(B) schematically illustrates an operating time of the transflective panel device in accordance with a seventh example of the present invention. FIG. 8(B) is similar to FIG. 7 except that the pulse width of the first driving signal in which the transmissive parts 21 of the pixels 2 are driven is larger than the pulse width of the second driving signal in which the reflective parts 22 of the pixels 2 are driven. The first and second driving units 31, 32 can freely drive the transmissive parts 21 and the reflective parts 22 of the pixels 2 in different pulse widths of the driving signal in a frame for improving efficiency and decreasing energy consumption, respectively.

In other examples, similarly, it is applicable that the pulse width of the second driving signal in which the reflective parts 22 of the pixels 2 are driven is larger than the pulse width of the first driving signal in which the transmissive parts 21 of the pixels 2 are driven.

FIG. 9 is a schematic diagram showing the operation of the transflective panel device according to the present invention. As shown in FIG. 9, the left-hand side of FIG. 9 represents that, when the ambient brightness is dark as indicated in Table 1, the pulse width of the first driving signal is larger than that of the second driving signal as shown in FIGS. 6(A), 6(B), or 8(A) and the scanning frequency of the first driving signal is higher than that of the second driving signal, while the backlight module 7 is driven for allowing the light to pass through the transmissive parts 21.

Alternatively, if the transmissive part scanning time has a scanning frequency of 50 Hz and the reflective part scanning time has a scanning frequency of 10 Hz in the operating time as shown in FIG. 5, the first frame of FIG. 5 is shown as the frame in FIG. 4, and the second to fifth frames of FIG. 5 are shown as the frames in FIGS. 6(A), 6(B), and 6(C), respectively, while the same arrangement is repeated.

Alternatively, if the transmissive part scanning time has a scanning frequency of 50 Hz and the reflective part scanning time has a scanning frequency of 10 Hz in the operating time, the first frame can be shown as the frame in FIG. 7, and the second to fifth frames can be shown as the frames in FIGS. 8(A), 6(B), and 8(B), respectively, while the same arrangement is repeated.

As shown in Table 1 and FIG. 9, the right-hand side of FIG. 9 represents that, when the ambient brightness is bright, the pulse width of the first driving signal is smaller than that of the second driving signal and the scanning frequency of the first driving signal is lower than that of the second driving signal, while the backlight module 7 doesn't be driven. The distribution of the transmissive parts 21 and the reflective parts 22 in one frame, as shown in FIGS. 6(A), 6(B), 6(C), 8(A), and 8(B), can be altered by swapping the transmissive parts 21 and the reflective parts 22 with each other.

As shown in Table 1 and FIG. 9, the middle part of FIG. 9 represents that, when the ambient brightness is between dark and bright, the pulse width of the first driving signal is longer than, shorter than, or equal to that of the second driving signal and the scanning frequency of the first driving signal is higher, lower than, or equal to than that of the second driving signal, while the backlight module 7 is driven in accordance with content adaptive brightness control (CABC) dimming for allowing the light to pass through the transmissive parts 21. The distribution of the transmissive parts 21 and the reflective parts 22 in one frame, as shown in FIGS. 6(A), 6(B), 6(C), 8(A), and 8(B), can be adjusted according to the adjustment value.

TABLE 1

| | Ambient brightness | | |
|---|---|---|---|
| | Dark | Medium | Bright |
| T part | Normal display | Normal display | Low frequency |
| | | | drive or black |
| | | | display |
| R part | Low frequency | Normal display | Normal display |
| | drive or black | | |
| | display | | |
| Backlight | Turn on | Turn on (CABC | Turn off |
| | | dimming) | |

As long as the adjustment unit 5 senses that the adjustment value is changed, the controller 6 can adjust the pulse width of the first and second driving signals and even adjust the scanning frequency of the first and second driving signals.

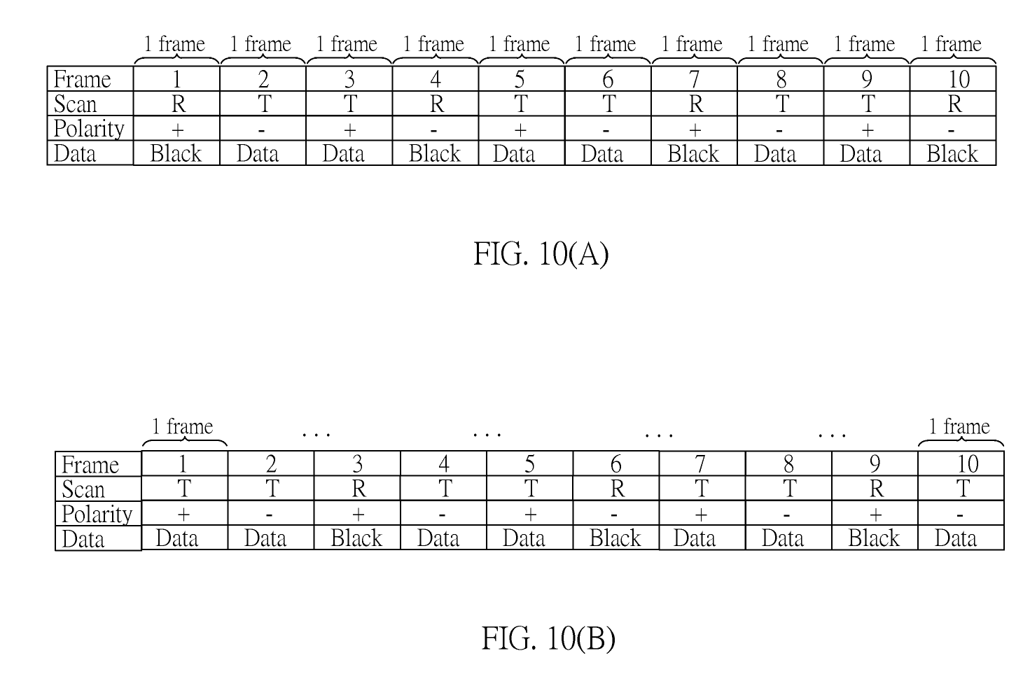

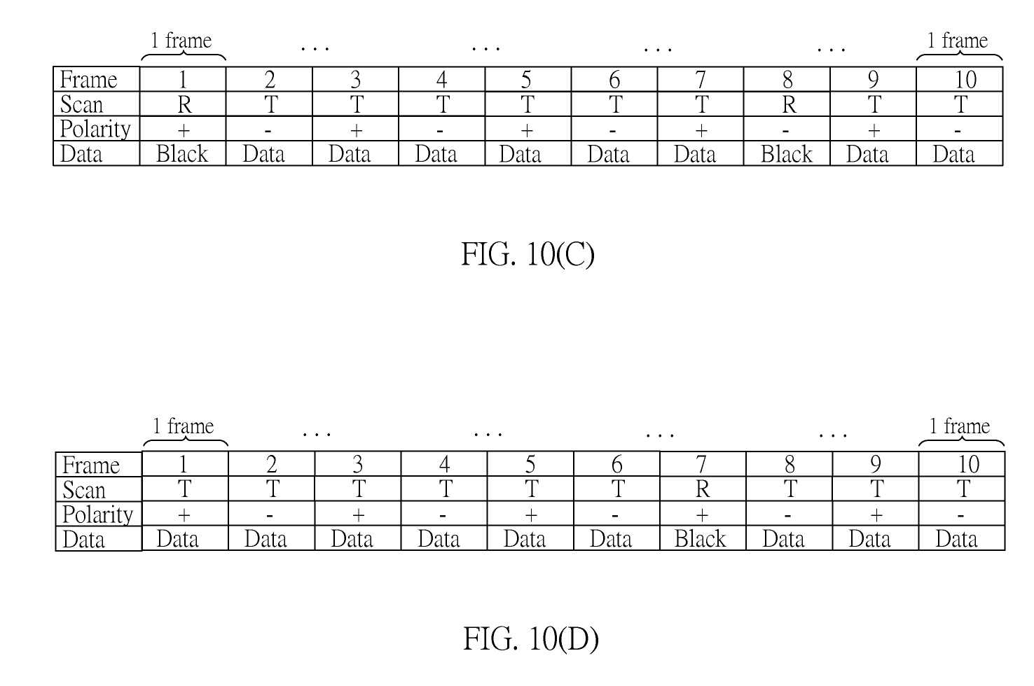

Besides, FIGS. 10(A)-10(D) are the driving diagrams of the transflective panel device for the transmissive mode in accordance with the present invention. As shown in FIG. 10(A), one frame that represents the operating time of an image for the transmissive parts 21 or for the reflective parts 22, wherein the first frame signal is for the reflective parts 22, the second and the third frame signals are for the transmissive parts 21 and the same arrangement is repeated in the following frames and the frame signals of the reflective parts 22 are black signal. Via the frame arrangement as shown in FIG. 10(A), it can keep data polarity balance in the transmissive parts 21 or in the reflective parts 22.

FIG. 10(B) is similar to FIG. 10(A) except that the first and the second frame signals are for the transmissive parts 21, the third frame signal is for the reflective parts 22 and the same arrangement is repeated in the following frames.

FIG. 10(C) is similar to FIG. 10(A) except that the first frame signal is for the reflective parts 22, the second to the seventh frame signals are for the transmissive parts 21 and the same arrangement is repeated in the following frames.

FIG. 10(D) is similar to FIG. 10(C) except that the first to the sixth frame signals are for the transmissive parts 21, the seventh frame signal is for the reflective parts 22 and the same arrangement is repeated in the following frames.

In other words, the driving diagrams for the transmissive mode as shown in FIG. 10(A) to (D), the frame signal for the reflective parts 22 appears one times while the frame signal for the transmissive parts 21 appears even times.

Alternatively, the driving diagrams for the reflective mode are similar to FIG. 10(A) to (D) except that the frame signal for the transmissive parts 21 appears one times while the frame signal for the reflective parts 22 appears even times.

Furthermore, when the adjustment unit 5 senses that the adjustment value is changed, the controller 6 can adjust the scanning times of the first and second driving signals.

Although the present invention has been explained in relation to its preferred embodiment, it is to be understood that many other possible modifications and variations can be made without departing from the spirit and scope of the invention as hereinafter claimed.

What is claimed is:

1. A transflective panel device, comprising:
a plurality of pixels arranged in columns and rows, each pixel including a transmissive part coupled to a first gate line and a reflective part coupled to a second gate line;
a gate driver including a first driving unit and a second driving unit, wherein the first driving unit is coupled to the first gate lines and drives the transmissive parts based on a first driving signal and the second driving unit is coupled to the second gate lines and drives the reflective parts based on a second driving signal;
wherein the first driving signal and the second driving signal are controlled independently.

2. The transflective panel device as claimed in claim 1, wherein a scanning frequency of the first driving signal is different from that of the second driving signal.

3. The transflective panel device as claimed in claim 1, wherein a pulse width of the first driving signal is different from that of the second driving signal.

4. The transflective panel device as claimed in claim 1, further comprising:
an adjustment unit for providing an adjustment value corresponding to an ambient brightness or a human controlling;
a backlight module for providing a light based on the adjustment value.

5. The transflective panel device as claimed in claim 4, wherein when the ambient brightness is dark, a scanning frequency of the first driving signal is higher than that of the second driving signal, and
when the ambient brightness is bright, a scanning frequency of the first driving signal is lower than that of the second driving signal.

6. The transflective panel device as claimed in claim 4, wherein when the ambient brightness is dark, a pulse width of the first driving signal is larger than that of the second driving signal, and
when the ambient brightness is bright, a pulse width of the first driving signal is smaller than that of the second driving signal.

7. The transflective panel device as claimed in claim 1, wherein the first driving unit is arranged at a first side of the plurality of pixels, and the second driving unit is arranged at a second side of the plurality of pixels opposite to the first side.

8. The transflective panel device as claimed in claim 1, wherein the first driving unit and the second driving unit are both arranged at same side of the plurality of pixels.

9. The transflective panel device as claimed in claim 4, wherein the adjustment unit is a light sensor for sensing the ambient light.

10. The transflective panel device as claimed in claim 4, wherein the adjustment unit is manually operated by user.
